(19) United States
(12) Patent Application Publication
(10) Pub. No.: US 2003/0042804 A1
(43) Pub. Date: Mar. 6, 2003

(54) THREE LAYER VIBRATION DAMPING WASHER FOR AN ELECTRIC MOTOR

(76) Inventors: Michael Andrew Cook, Silver Lake, IN (US); Vijay Pal Singh Charhar, Fort Wayne, IN (US); Kerry Baker Shelton, Fort Wayne, IN (US); Timothy Wilbur Carey, Kendallville, IN (US)

Correspondence Address: John S. Beulick, Armstrong Teasdale LLP, Suite2600, One Metropolitan Sq., St. Louis, MO, 63102, US

(21) Appl. No.: 09/750,414

(22) Filed: Dec. 28, 2000

Related U.S. Application Data
(60) Provisional application No. 60/174,002, filed on Dec. 30, 1999.

(51) Int. Cl. H02K 5/24

(52) U.S. Cl. 310/51; 310/91

(57) ABSTRACT

A motor including a washer assembly that facilitates reducing or eliminating end bump noise generated as a result of a rotor contacting a bearing assembly during motor operation is described. The rotor assembly includes a shaft rotatably supported within the housing with a pair of bearing assemblies. Each washer assembly includes a snap ring and a damping washer. The damping washer includes three layers, wherein the first and third layers are fabricated from a wear resistant material and the second layer is between the first and third layers, and is fabricated from an energy absorbing material.

### CROSS REFERENCE TO RELATED APPLICATION

This application claims the benefit of U.S. Provisional Application No. 60/174,002 filed Dec. 30, 1999.

### BACKGROUND OF THE INVENTION

This invention relates generally to motors and, more particularly, to structures for damping axial motion of a rotor within the motor.

Motors often operate in situations in which the motors are operated intermittently, and in areas in which it is desirable to reduce noise. Motors typically include a rotor mounted within a stator. The rotor includes a shaft rotatably coupled to a bearings. The motor also includes a pair of endshields which house the motor, and include an opening sized to receive the rotor shaft therethrough. The rotor shaft extends through the end shield openings which maintain the rotor in place.

Typically when a motor is first energized for operation, the rotor moves axially to align with a stator magnetic field. The axial movement of the rotor may cause a snap-ring coupled to the rotor shaft to contact the bearing and generate a noise. Such contact is known as “end bump”, and depending upon an operating environment of the motor, the resulting noise may be highly undesirable and particularly objectionable. For example, rotary motors commonly drive fans and compressors in appliances such as refrigerators, forced air heaters, and air conditioning units, and in radiator fans in automobiles. In these and other situations in which the motor operates in close proximity to people, excessive noise is undesirable, and may decrease a value of the product containing the motor.

To facilitate reducing noise generated as a result of end bump, at least some known motors include damping systems. Such systems are complex multi-piece assemblies that may be time-consuming to assemble. Furthermore, because of the complexity of such systems, inadvertent assembly errors may occur.

### BRIEF SUMMARY OF THE INVENTION

In an exemplary embodiment, a motor includes a washer assembly that facilitates reducing or eliminating end bump noise generated as a result of a rotor contacting a bearing assembly during motor operation. The motor includes a stator assembly and a rotor assembly housed within a housing. The rotor assembly includes a rotor shaft rotatably coupled and supported within the housing with a pair of bearing assemblies adjacent each end of the housing. Each washer assembly includes a snap ring and a damping washer. The damping washer includes three layers. The first and third layers are fabricated from a wear resistant material and the second layer is fabricated from an energy absorbing material and is positioned between the first and third layers. The damping washer is positioned on the rotor shaft adjacent the bearing.

During operation, as the motor is initially energized, the rotor assembly moves axially to align with a magnetic field generated within the stator assembly. When the rotor shaft contacts the bearing assembly, the damping washer damps vibrations and noise that may be generated as a result of such contact. As a result, the bearing assembly eliminates more costly damping systems and provides a system that is reliable and cost-effective.

### BRIEF DESCRIPTION OF THE DRAWINGS

FIG. 1 is an exploded perspective view of an exemplary embodiment of a motor including a bearing assembly;

FIG. 2 is a cross-sectional view of the assembled motor shown in FIG. 1; and

FIG. 3 is an enlarged partial cut-away perspective view of the assembled motor shown in FIG. 2.

### DETAILED DESCRIPTION OF THE INVENTION

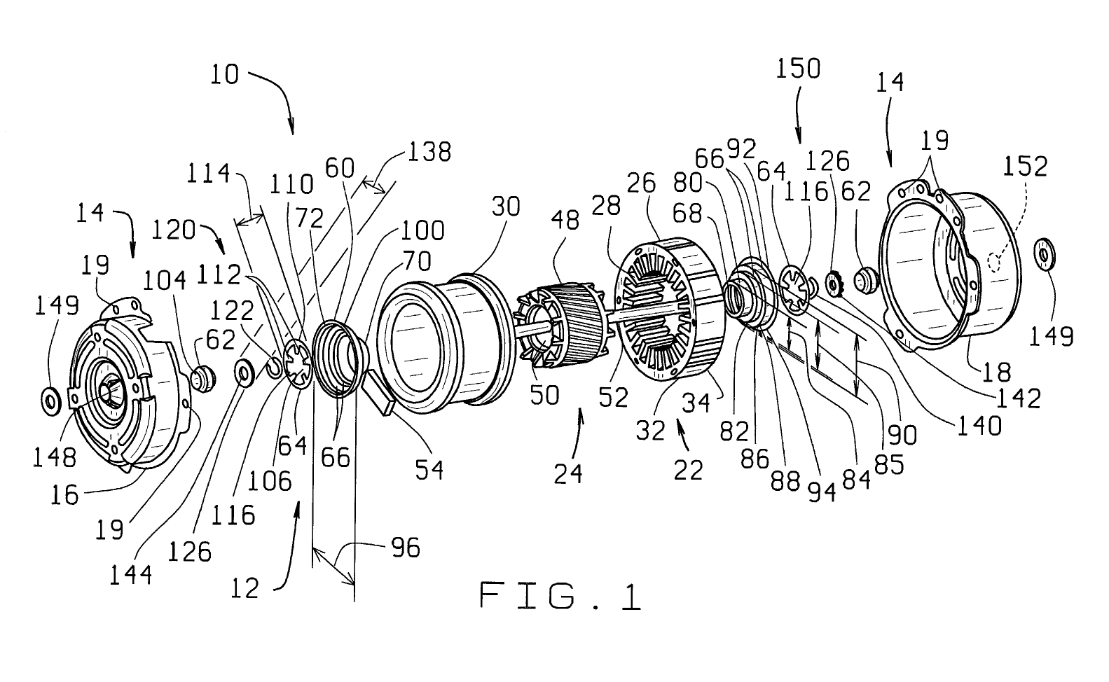

FIG. 1 is an exploded perspective view of a motor 10 including a bearing assembly 12 and a motor housing assembly 14. Motor housing assembly 14 includes an end cap 16 and a can 18. End cap 16 and can 18 each include a plurality of openings 19 and 20 respectively to permit end cap 16 and can 18 to connect together with a plurality of fasteners (not shown) to form a cavity (not shown in FIG. 1). Additionally, end cap 16 and can 18 support bearing assembly 12 which supports motor 10. In one embodiment, end cap 16 and can 18 are deep-drawn steel end shields.

A stator assembly 22 and a rotor assembly 24 are positioned within the cavity created by end cap 16 and can 18. Stator assembly 22 includes a stator core 26 with a stator bore 28 extending therethrough. Stator core 26 provides a framework for a plurality of stator windings 30 to be wound through. Rotor assembly 24 is positioned within stator bore 28 and includes a rotor core 48, a rotor bore 50, and a rotor shaft 52. Rotor bore 50 extends through rotor core 48 and rotor shaft 52 extends through rotor bore 50.

An overload protection assembly 54 is installed within motor 10 adjacent stator winding 26. Overload protection assembly 54 is temperature sensitive such that if stator winding 26 reaches a pre-determined temperature during motor operation, then overload protection assembly 54 cuts power to motor 10 to prevent the temperature from rising to a potentially damaging level within stator winding 26.

A first end (not shown in FIG. 1) of rotor shaft 52 extends axially from stator core first side 32 through bearing assembly 12. Bearing assembly 12 includes an oil-well cover 60, a bearing 62, and a retaining spring 64. Oil-well cover 60 has a generally frusto-conical cross-sectional profile and includes a plurality of ledges 66 and an opening 68. Opening 68 extends through oil-well cover 60 from a first side 70 of oil-well cover 60 to a second side 72 of oil-well cover 60 and permits the first end of rotor shaft 52 to extend therethrough. Oil-well cover 60 is installed such that oil-well cover first side 70 is closer to stator core 26 than is oil-well cover second side 72. In one embodiment, oil-well cover 60 is drawn sheet metal.

Oil-well cover 60 includes a first body portion 80 extending from first side 70 to a first ledge 82. First body portion 80 has a first diameter 84 less than a second diameter 85 of first ledge 82. A second body portion 86 extends from first ledge 82 to a second ledge 88. Second ledge 88 has a third diameter 90 larger than first ledge diameter 85. A third body portion 92 extends from second ledge 88 to a third ledge 94. Third ledge 94 is adjacent oil-well cover second side 72 and forms a bottom flange for oil-well cover 60. Third ledge 94 has a fourth diameter 96 larger than second ledge diameter 90.

Oil-well cover second side 72 is press-fit in an interference fit into end cap 16. A cavity 100 is created between oil-well cover 60 and end cap 16 that is sealed from the outside environment. A lubricating material (not shown) is injected into cavity 100 before motor 10 is fully assembled. In one embodiment, lubricating material is a Permawick® lubricating material.

Bearing 62 supports rotor 24 and maintains rotor core 48 in proper alignment with stator core 26. Bearing 62 includes an opening 104 extending through bearing 62 that permits the first end of rotor shaft 52 to extend through bearing 62. Bearing 62 contacts a spherical bearing socket (not shown in FIG. 1) within end cap 16. In one embodiment, bearing 62 is a sintered-iron bearing. Bearing 62 includes a plurality of pores (not shown) which provide lubrication to rotor shaft 52.

Bearing 62 is held in alignment against the spherical bearing socket by retaining spring 64 which includes an opening 106. Opening 106 permits the first end of rotor shaft 52 to extend therethrough. Retaining spring 64 includes an annular body 110 and a plurality of fingers 112. Annular body 110 has a diameter 114 larger than oil-well first body portion diameter 84. Diameter 114 is smaller than oil-well first ledge diameter 85. Fingers 112 extend radially inward from annular body 110 towards rotor shaft 52. In one embodiment, retaining spring 64 includes five fingers 112. Fingers 112 are circumferentially spaced around annular body 110 such that spaces 116 exist between adjacent fingers 112. Spaces 116 permit lubricating material to be injected through retaining spring 64 into oil-well cover 60. After motor 10 is fully assembled, fingers 112 engage bearing 62 and provide an axial force against bearing 62 to retain bearing 62 within the bearing socket while retaining spring 64 contacts oil-well first ledge 82.

The first end of rotor shaft 52 extends through a washer assembly 120 positioned between rotor core 48 and bearing 62. Washer assembly 120 provides axial support for minor thrust loads caused by motor 10. Washer assembly 120 includes a snap ring 122 and a damping washer 126. Damping washer 126 is a three layer washer that is described in more detail below. Rotor shaft 52 includes a slot (not shown) that snap ring 122 fits within. The slot positions and orients snap ring 122 and fixes snap ring 122 to shaft 52. Damping washer 126 has a diameter 138. In one embodiment, damping washer diameter 138 is approximately 0.50 inches.

Damping washer 126 is adjacent snap ring 122 and is between snap ring 122 and a thrust surface. In one embodiment, the thrust surface is bearing 62. Rotor shaft 52 extends through an opening 140 disposed within snap ring 122 and through an opening 142 within damping washer 126. An opening 148 in end cap 16 permits rotor shaft 52 to extend through end cap 16 and permits end cap 16 to provide support for rotor shaft 52. A water thrower 149 is attached to rotor shaft 52 to dispel water accumulating from rotor shaft 52.

A second end (not shown in FIG. 1) of rotor shaft 52 extends axially from stator core second side 34 into a second bearing assembly 150. Bearing assembly 150 is constructed identically to bearing assembly 12 except that second bearing assembly oil-well cover 60 is press-fit into can 18. The second end of rotor shaft 52 passes through bearing assembly 150 and through an opening 152 in can 18 which supports rotor shaft 52.

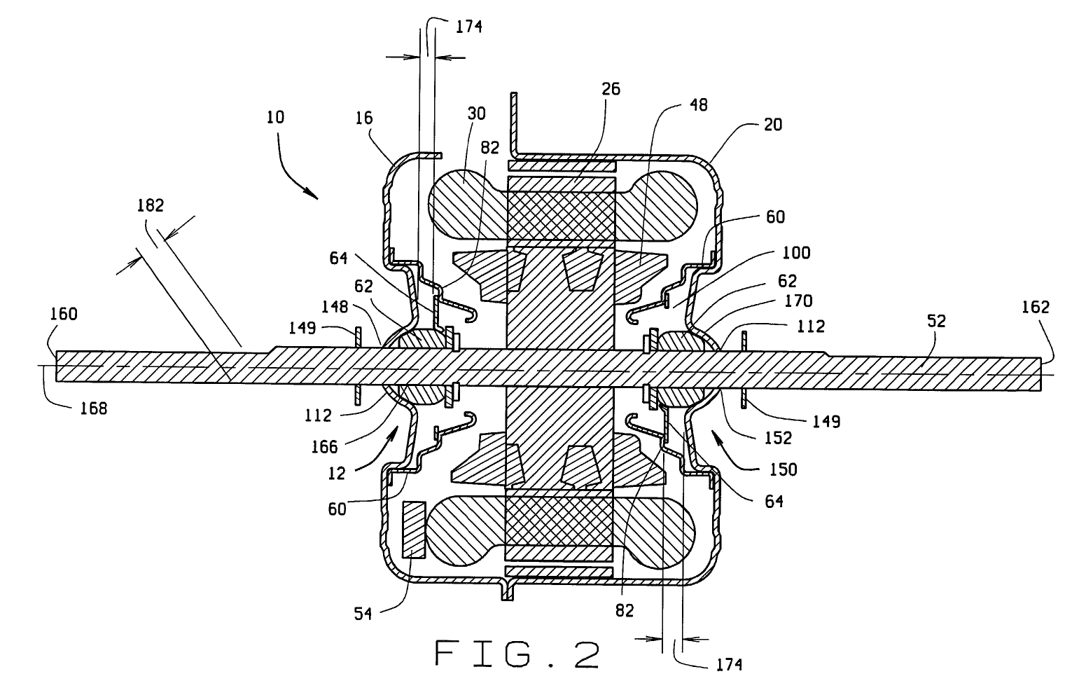

FIG. 2 is a cross-sectional view of an assembled motor 10. Rotor shaft 52 extends from a first end 160 of rotor shaft 52 through motor 10 to a second end 162 of rotor shaft 52. First end 160 extends through opening 148 within a bearing socket 166 formed within end cap 16. Bearing socket 166 is concentric with respect to opening 148 and to an axis of symmetry 168 of motor 10 and is spherical-shaped. Bearing 62 is housed within bearing socket 166. Similarly, rotor shaft second end 162 extends through opening 152 within a bearing socket 170 formed within can 18. Bearing socket 170 is constructed identically to bearing socket 166 and houses bearing 62 of bearing assembly 150.

When motor 10 is fully assembled, each bearing 62 is retained in a respective bearing socket 166 and 170 with retaining springs 64. Oil-well covers 60 are press-fit against end cap 16 and can 18 and each retaining spring 64 rests against a respective first ledge 82 of each oil-well cover 60 a distance 174 from end cap 16 and can 18 respectively. The spherical shape of end cap bearing socket 166 and can bearing socket 170 permits bearings 62 to rotate within sockets 166 and 170 while retaining spring fingers 112 permit bearings 62 to move axially while rotating. The combination of the rotation within spherical sockets 166 and 170 and axial movement towards each retaining spring 64 permits each bearing 62 to self-align with respect to the other bearing 62. Retaining spring 64 provides enough axial force on bearing 62 to retain bearing 62 within each respective socket 166 and 170 without preventing each bearing 62 from moving axially and self-aligning. Additionally, the axial force exerted by each retaining spring 64 ensures that each bearing 62 maintains proper alignment despite customer side-loads induced on rotor shaft 52 by equipment (not shown) attached to either rotor shaft end 160 and 162 and despite any magnetic side-pull induced from rotor core 48.

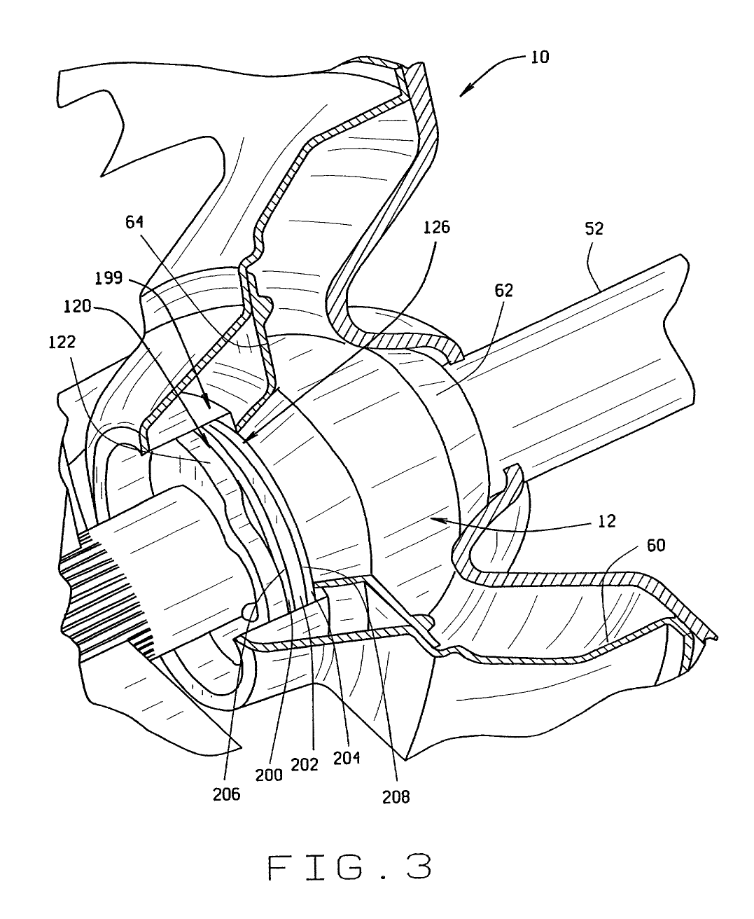

FIG. 3 is a cut-away perspective view of motor 10 including bearing assembly 12 and washer assembly 120. Damping washer 126 includes a plurality of layers 190. More specifically, damping washer 126 includes a first layer 200, a second layer 202, and a third layer 204. First layer 200 is identical with third layer 204 and each layer 200 and 204 is semi-rigid. More specifically, first layer 200 and third layer 204 are fabricated from a wear-resistant material. In one embodiment, layers 200 and 204 are fabricated from at least one of fiber, phenolic plastics, and nylon. In another embodiment, layers 200 and 204 are fabricated from other wear-resistant materials known in the art.

First layer 200 contacts a first side 206 of second layer 202, and third layer 204 contacts a second side 208 of second layer 202, such that second layer 202 is sandwiched between first layer 200 and third layer 204. Second layer 202 is fabricated from an oil-resistant, energy-absorbing material. In one embodiment, second layer 202 is fabricated from at least one of foam and rubber. In another embodiment, second layer 202 is fabricated from closed-cell foam. In a further embodiment, second layer 202 is fabricated from other oil-resistant and energy-absorbing materials known in the art.

First and third layers 200 and 204, respectively, are bonded to second layer 202 such that each damping washer layer 200, 202, and 204 is formed integrally with each other damping washer layer 200, 202, and 204. More specifically, layers 200 and 204 are bonded to second layer 202 using methods known in the art. In one embodiment, layers 200 and 204 are bonded to layer 202 with an adhesive. Because first layer 100 is identical with third layer 204, during assembly of motor 10, damping washer 126 may be positioned between snap ring 122 and bearing 62, such that either first layer 200 or third layer 204 is adjacent snap ring 122. As a result, layers 200 and 204 provide a low-friction surface between snap ring 122 and bearing 62.

Washer 126 is fabricated using methods known in the art. In one embodiment, wear-resistant material is bonded to resilient material with adhesive and washer 126 is stamped from a three-layer composite. In an another embodiment, toroidal pieces of wear-resistant material and of resilient material are fabricated, and then bonded to each other to generate washer 126.

During operation, as motor 10 is initially energized, rotor assembly 24 (shown in FIG. 1) moves axially to align with a magnetic field generated within stator assembly 22 (shown in FIG. 1). When rotor shaft 52 contacts bearing assembly 12, damping washer 126 damps vibrations that may be generated as a result of such contact, and thus, facilitates reducing or eliminating any noise generated as a result of such contact. More specifically, because washer outer layers 200 and 204 are semi-rigid, washer 126 is adapted to flexurally absorb vibrational movements of snap ring 122 relative to bearing 62.

While the invention has been described in terms of various specific embodiments, those skilled in the art will recognize that the invention can be practiced with modification within the spirit and scope of the claims.

What is claimed is:

1. A method for assembling a motor to facilitate reducing vibrational noise generated as a result of a rotor assembly contacting a bearing assembly, the motor including at least one bearing assembly and at least one washer assembly, the rotor assembly including a rotor shaft, the washer assembly including a snap ring and a damping washer, said method comprising the steps of:
providing a damping washer including a plurality of layers including at least one layer fabricated from an energy-absorbing material;
inserting the rotor shaft through the washer assembly such that the damping washer is between the snap ring and the bearing assembly; and
supporting the rotor shaft within the motor with each bearing assembly such that each damping washer is adjacent each bearing assembly.

2. A method in accordance with claim 1 wherein said step of providing a damping washer further comprises the step of providing a damping washer including a first semi-rigid layer, a second resilient layer and a third semi-rigid layer, the first layer identical with the third layer.

3. A method in accordance with claim 2 wherein said step of inserting a rotor shaft further comprises the step of positioning the damping washer such that at least one of the damping washer first layer and damping washer third layer is adjacent the snap ring.

4. A method in accordance with claim 2 wherein said step of inserting a rotor shaft further comprises the step of positioning the damping washer such that at least one of the damping washer first layer and damping washer third layer is adjacent the thrust bearing.

5. A method in accordance with claim 2 wherein said step of providing a damping washer further comprises the step of providing a damping washer including a first and third layer fabricated from a wear-resistant material, and a second layer fabricated from an oil-resistant material, such that the first and third layers are each bonded to the second layer.

6. A motor comprising:
a motor housing comprising an end cap and a can, said end cap connected to said can and comprising an opening, said can comprising an opening;
a stator assembly positioned within said motor housing and comprising a stator core and a stator bore extending therethrough, said stator core comprising a plurality of stator windings;
a rotor assembly positioned within said stator bore, said rotor assembly comprising a rotor core, a rotor bore disposed through said rotor core, and a rotor shaft extending through said rotor bore, said end cap opening, and said can opening;
a bearing positioned on said rotor shaft adjacent said end cap; and
a washer comprising a first layer, a second layer and a third layer, said second layer different from said first and third layers, said washer positioned on said rotor shaft adjacent said bearing and configured to dampen vibrations induced from said rotor shaft.

7. A motor in accordance with claim 6 further comprising a snap ring affixed to said shaft, said washer adjacent said snap ring.

8. A motor in accordance with claim 6 wherein said washer first and third layers identical and fabricated from a semi-rigid material, said washer second layer fabricated from a resilient material and between said washer first and third layers.

9. A motor in accordance with claim 6 wherein said first, second, and third layers are bonded together.

10. A motor in accordance with claim 6 wherein said washer first and third layers comprise an oil-resistant material, said second layer comprises an energy-absorbing material.

11. A motor in accordance with claim 6 wherein said washer second layer comprises material selected from the group consisting of foam and rubber.

12. A motor in accordance with claim 6 wherein said washer first and third layers comprise wear resistant material.

13. A motor in accordance with claim 12 wherein said washer first and third layers comprise material selected from the group consisting of fiber, phenolic plastics, and nylon.

14. A washer assembly for a motor, the motor including an end cap and a rotor shaft including a bearing thereon, said washer assembly configured to reduce vibrational stresses induced from the rotor shaft, said washer assembly comprising:
a damping washer comprising a first layer, a second layer and a third layer; said second layer different from said first and third layers; and
a snap ring adjacent said damping washer.

15. An assembly in accordance with claim 14 wherein said damping washer first and third layers fabricated from a semi-rigid material, said damping washer second layer fabricated from a resilient material.

16. An assembly in accordance with claim 14 wherein said damping washer second layer between said damping washer first and third layers, said washer assembly positioned on the rotor shaft adjacent the bearing.

17. An assembly in accordance with claim 14 wherein said damping washer second layer comprises an oil-resistant and energy-absorbing material, said first and third layers comprise a wear resistant material, said first layer identical with said third layer.

18. An assembly in accordance with claim 14 wherein said second layer comprises a material selected from the group consisting of foam and rubber, said first and third layers comprise a material selected from the group consisting of fiber, phenolic plastics, and nylon.
